(19) United States
(12) Patent Application Publication
(10) Pub. No.: US 2012/0189920 A1
(43) Pub. Date: Jul. 26, 2012

(54) Non-Aqueous Electrolytic Solutions And Electrochemical Cells Comprising The Same

(75) Inventors: Wentao Li, Solon, OH (US); Martin W. Payne, Avon, OH (US)

(73) Assignee: NOVOLYTE TECHNOLOGIES INC., Cleveland, OH (US)

(21) Appl. No.: 13/012,832

(22) Filed: Jan. 25, 2011

(51) Int. Cl. H01M 10/052; H01M 10/04; H01M 10/02

(52) U.S. Cl. 429/331; 29/623.2; 29/623.1; 429/332

(57) ABSTRACT

A lithium secondary battery having reduced swelling tendency includes an electrolytic solution. The electrolytic solution includes a lithium salt, a cyclic carbonate, a linear asymmetric carbonate, a third carbonate, a sultone and a phosphazene compound.

### FIELD OF THE INVENTION

The present invention relates to a non-aqueous electrolytic solution and an electrochemical energy storage device comprising the same. More particularly, this invention pertains to non-aqueous electrolytic solutions that comprise (a) one or more solvents; (b) one or more ionic salts; and (c) one or more additives. Non-aqueous electrolytic solutions capable of protecting either negative electrode materials, such as lithium metal and carbonaceous materials, or positive electrode materials, such as metal composite oxide containing lithium, or both, in energy storage electrochemical cells (e.g., lithium metal batteries, lithium ion batteries and supercapacitors) include a cyclic carbonate, a linear carbonate, a sultone, and a phosphazene compound. Such electrolyte solutions enhance the battery performance; notable are significant reduction in cell swelling and capacity degradation during cycling and high temperature storage.

### BACKGROUND

State-of-the-art lithium ion batteries commonly use electrolytes containing lithium hexafluorophosphate (LiPF₆) as solute and mixtures of cyclic carbonates and linear carbonates as solvents. Ethylene carbonate (EC) is the indispensable cyclic carbonate for the formation of stable solid electrolyte interface (SEI) at the surface of the negative electrode so that good battery performance can be achieved or enhanced, especially long cycle life.

However, in many cases the SEI protection from conventional electrolytes with simple formulations such as LiPF₆ in mixtures of EC and linear carbonates is insufficient in lithium ion batteries where the negative electrode materials are carbonaceous materials including graphite carbons and non-graphite carbons, for example inexpensive natural graphite (a kind of graphite carbon) and hard carbon (a kind of amorphous non-graphite carbon), which exhibits a higher initial discharge capacity but quickly loses capacity in subsequent cycles.

On the other hand, lithium ion batteries employing high capacity cathode materials, especially those with a large amount of nickel content, are desirable for longer run time in various applications.

Swelling of lithium ion batteries is a commonly encountered problem, especially with above-mentioned nickel-rich cathode materials. Swelling means volume increase of the cells, caused by generation of gaseous products from either degradation of the electrolyte and SEI film, or reactions between the electrolyte and the electrode materials. The swelling, as demonstrated by an increase in thickness as in prismatic cells, may cause rupture of the case or increase of required space for battery packs. Besides, swelling is usually accomplished by resistance increase, open-cell voltage decrease and/or capacity loss of the cell. The problem is especially significant when the cells are stored in a charged state at elevated temperatures.

Various approaches have been disclosed in the attempt to reduce or eliminate swelling for the lithium ion batteries. In U.S. 2008/0233485, a cyclic ether, such as furan, in combination with vinylene carbonate, was shown to reduce the swelling of the battery. In U.S. 2005/0233207, a mixed additive of 2-sulfobenzoic acid cyclic anhydride and divinyl sulfone were reported to reduce swelling. U.S. Pat. No. 7,510,807 disclosed that the addition of 1-alkyl-2-pyrrolidone based compound in combination with fluoroethylene carbonate reduced swelling for a pouch-type battery cell. Each approach has its problems. For example, capacity retention of the cells may deteriorate. Therefore, in order to prevent swelling of lithium ion batteries caused by gas generation from the reaction among SEI layer, negative electrode, positive electrode and electrolytes, further innovation is needed such that other characteristics of the cells may also improve.

### SUMMARY OF THE INVENTION

The present invention provides a non-aqueous electrolytic solution having a suppressed swelling, a long cycle life and high capacity retention for lithium metal and lithium ion battery using the same. In particular, the present invention provides a non-aqueous electrolytic solution having at least one cyclic carbonate, at least one linear asymmetric carbonate, a third carbonate different from the others, a sultone, and a phosphazene compound.

More precisely, the invention relates to a secondary battery comprising: (a) an anode, (b) a cathode, and, (c) an electrolytic solution, comprising (i) a lithium salt, (ii) ethylene carbonate, (iii) ethyl methyl carbonate, (iv) a third carbonate different from the others, (v) propane sultone, and (vi) a phosphazene compound.

Such electrolytic solutions help to prevent or reduce swelling in a lithium secondary battery. Beneficial side effects may include the formation of a good solid-electrolyte interface (SEI) on the negative electrode surface of the batteries, better stability of the electrolyte and better interaction between the electrolyte and electrodes. Batteries using the electrolytic solutions with such additives have long life, high capacity retention and less swelling problems.

The electrolytic solution in the present invention comprises (a) one or more solvents, (b) one or more lithium salts, and (c) one or more additives. Typical lithium salts include LiPF₆, LiBF₄, LiAsF₆, LiClO₄, LiCF₃SO₃, LiN(SO₂CF₃)₂, LiN(SO₂F)₂, LiB(C₂O₄)₂ (i.e. LiBOB), LiBF₂C₂O₄ (i.e. LiDFOB), LiF₄(C₂O₄) (LiFOP), Li₂B₁₂FₓH₍ₗ₂₋ₓ₎ where x=0-12, and others, while typical solvents include ethylene carbonate (EC), propylene carbonate (PC), dimethyl carbonate (DMC), diethyl carbonate (DEC), ethylmethyl carbonate (EMC), γ-butyrolactone (GBL), methyl butyrate (MB), propyl acetate (PA), butyl acetate (BA) and others.

An embodiment of the invention is a secondary battery comprising an anode, a cathode, and an electrolytic solution, the electrolytic solution comprising a lithium salt, a cyclic carbonate, a linear asymmetric carbonate, a third carbonate different from the others, a sultone, and a phosphazene compound.

In a preferred embodiment, a secondary battery comprises an anode, a cathode, and an electrolytic solution, the electrolytic solution comprising a lithium salt, a cyclic carbonate, a linear asymmetric carbonate, a third carbonate different from the others, propane sultone, and a phosphazene compound.

These and other features and advantages of the present invention will become more readily apparent to those skilled in the art upon consideration of the following detailed description that described both the preferred and alternative embodiments of the present invention.

### DETAILED DESCRIPTION OF THE INVENTION

The following embodiments describe the preferred mode presently contemplated for carrying out the invention and are not intended to describe all possible modifications and variations consistent with the spirit and purpose of the invention. These and other features and advantages of the present invention will become more readily apparent to those skilled in the art upon consideration of the following detailed description that describes both the preferred and alternative embodiments of the present invention.

An embodiment of the invention is a secondary battery comprising an anode, a cathode, and an electrolytic solution, the electrolytic solution comprising a lithium salt, a cyclic carbonate, a linear asymmetric carbonate, a third carbonate different from the others, a sultone, and a phosphazene compound.

In a preferred embodiment, a secondary battery comprises an anode, a cathode, and an electrolytic solution, the electrolytic solution comprising a lithium salt, a cyclic carbonate, a linear asymmetric carbonate, a third carbonate different from the others, propane sultone, and a phosphazene compound.

Another embodiment of the invention is a method of making a lithium battery or lithium ion battery comprising: (a) providing an electrolytic solution comprising (i) a non-aqueous electrolytic solution comprising (1) a lithium salt, (2) ethylene carbonate, (3) ethyl methyl carbonate, (4) a third carbonate, (5) propane sultone, and (6) a phosphazene compound, (b) stacking atop one another (1) a first porous separator, (2) a cathode, (3) a second porous separator, and (4) an anode, (c) wrapping the electrodes and separators of (b) tightly together using adhesive to form an assembly, (d) inserting the assembly into an open-ended prismatic aluminum can, (e) attaching respective current leads to respective anode and cathode, (f) adding the electrolytic solution of (a) to the can, and (g) sealing the can.

In one embodiment, the non-aqueous electrolytic solution comprises: (a) 5-25% LiPF₆, (b) 15-50% ethylene carbonate, (c) 35-70% ethyl methyl carbonate, (d) 0.01-5% vinylene carbonate, (e) 0.01-5% ethoxypentafluorocyclotriphosphazene, and (f) 0.01-5% propane sultone.

Another embodiment of the invention is a method of reducing swelling in a lithium battery or lithium ion battery (as defined by increase in cell thickness measured after storage at 60° C. for 7 days) comprising: fabricating a lithium secondary battery including a non-aqueous electrolytic solution, wherein the non-aqueous electrolytic solution includes (i) LiPF₆, (ii) ethylene carbonate (EC), (iii) ethyl methyl carbonate (EMC), (iv) vinylene carbonate (VC), (v) propane sultone (PS), and (vi) a phosphazene compound.

Various embodiments of the invention are set forth in Table 1.

TABLE 1
Ranges of constituents in non-aqueous electrolytic solutions.

| Constituent | Wt % | | | | |
|---|---|---|---|---|---|
| Lithium salt | 5-25 | 8-20 | 10-18 | 10-15 | 12-13 |
| Cyclic carbonate | 15-50 | 20-45 | 25-40 | 25-35 | 30-35 |
| Linear carbonate | 35-70 | 40-65 | 45-60 | 50-60 | 50-55 |
| Third carbonate | 0-5 | 0.1-4 | 0.5-3 | 0.7-2 | 0.9-1.5 |
| Phosphazene | 0.01-10 | 0.1-8 | 0.5-7 | 0.7-5 | 1-3 |
| Sultone | 0.01-5 | 0.1-4 | 0.5-3 | 0.7-2 | 0.9-1.5 |

Broadly, the invention provides a secondary battery comprising an anode, a cathode, and an electrolytic solution. The electrolytic solution comprises a non-aqueous electrolytic solvent, a salt, and additives. The major components, solvent, salt, anode and cathode are each described in turn herein below.

Solvents. The solvents to be used in the secondary batteries of the invention can be any of a variety of are a mixture of non-aqueous, aprotic, and polar organic compounds. Generally, solvents may be carbonates, carboxylates, ethers, lactones, sulfones, phosphates, and nitriles. Useful additional carbonate solvents herein include but are not limited to cyclic carbonates such as propylene carbonate, butylene carbonate, and linear carbonates such as dimethyl carbonate, diethyl carbonate, di(2,2,2-trifluoroethyl) carbonate, dipropyl carbonate, dibutyl carbonate, ethyl methyl carbonate, 2,2,2-trifluorethyl methyl carbonate, methyl propyl carbonate, ethyl propyl carbonate, and 2,2,2-trifluorethyl propyl carbonate. Useful carboxylate solvents include but are not limited to methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, butyl butyrate. Useful ethers include but are not limited to tetrahydrofuran, 2-methyl tetrahydrofuran, 1,3-dioxolane, 1,4-dioxane, 1,2-dimethoxyethane, 1,2-diethoxyethane, 1,2-dibutoxyethane, methyl nonafluorobutyl ether, ethyl nonafluorobutyl ether. Useful lactones include but are not limited to γ-butyrolactone, 2-methyl-γ-butyrolactone, 3-methyl-γ-butyrolactone, 4-methyl-γ-butyrolactone, β-propiolactone, and δ-valerolactone. Useful phosphates include but are not limited to trimethyl phosphate, triethyl phosphate, tris(2-chloroethyl)phosphate, tris(2,2,2-trifluoroethyl)phosphate, tripropyl phosphate, triisopropyl phosphate, tributyl phosphate, trihexyl phosphate, triphenyl phosphate, tritolyl phosphate, methyl ethylene phosphate and ethyl ethylene phosphate. Useful sulfones include but are not limited to non-fluorinated sulfones such as dimethyl sulfone, ethyl methyl sulfone, partially fluorinated sulfones such as methyl trifluoromethyl sulfone, ethyl trifluoromethyl sulfone, methyl pentafluoroethyl sulfone, ethyl pentafluoroethyl sulfone, and fully fluorinated sulfones such as di(trifluoromethyl)sulfone, di(pentafluoroethyl)sulfone, trifluoromethyl pentafluoroethyl sulfone, trifluoromethyl nonafluorobutyl sulfone, pentafluoroethyl nonafluorobutyl sulfone. Useful nitriles include but are not limited to acetonitrile, propionitrile, and butyronitrile. Two or more of these solvents may be used in mixtures. Other solvents may be used as long as they are non-aqueous and aprotic, and are capable of dissolving the salts, such as N,N-dimethyl formamide, N,N-dimethyl acetamide, N,N-diethyl acetamide, and N,N-dimethyl trifluoroacetamide. Most preferred are ethylene carbonate and ethylmethyl carbonate.

The electrolytic solution in the present invention may further comprise one or more additives, such as a sultone (e.g., 1,3-propane sultone, and 1,4-butane sultone), an acidic anhydride (e.g. succinic anhydride), nitriles (e.g. succinonitrile) and/or phosphazenes. Phosphazenes are a class of chemical compounds wherein a phosphorus atom is covalently linked to a nitrogen atom by a double bond and to three other atoms or radicals by single bonds. Suitable phosphazenes include (singly or in combination) ethoxy-pentafluorocyclotriphosphazene, phenoxy-pentafluorocyclotriphosphazene, diethyl-tetrafluorocyclotriphosphazene, N-methyl-trifluorophophazene, N-ethyl-trifluorophophazene, phosphazene E, and phosphazene O.

The additives serve to prevent or to reduce gas generation of the electrolytic solution as the battery is charged and discharged at temperatures higher than ambient temperature.

Further additives to the electrolytic solution may include one or more of vinylene carbonate, vinyl ethylene carbonate, 4-methylene-1,3-dioxolan-2-one and 4,5-dimethylene-1,3-dioxolan-2-one. The total concentration of 4-methylene-1,3-dioxolan-2-one and 4,5-dimethylene-1,3-dioxolan-2-one in the solution preferably does not exceed about 10 wt %.

The electrolytic solution includes a cyclic carbonate, a linear carbonate and/or other non-aqueous, aprotic, and polar organic compounds as noted hereinabove. Overall, the non-aqueous electrolytic solution comprises about 10% to about 99% by weight, preferably about 40% to about 97% by weight, and more preferably about 60% to about 95% by weight of one or more solvents. The solvents include a cyclic carbonate, a linear asymmetric carbonate, a third carbonate different from the others that structurally resembles one of the commonly used solvent but may comprise one or more double bonds which will assist the formation of a stable SEI layer.

Salts. The solute of the electrolytic solution of the invention is an ionic salt containing at least one metal ion. Typically this metal ion is lithium (Li⁺). The salts herein function to transfer charge between the negative electrode and the positive electrode of a battery. The lithium salts are preferably halogenated, for example, LiPF₆, LiBF₄, LiSbF₆, LiAsF₆, LiTaF₆, LiAlCl₄, Li₂B₁₀Cl₁₀, Li₂B₁₀F₁₀, LiClO₄, LiCF₃SO₃, Li₂B₁₂FₓH₍₁₂₋ₓ₎ wherein x=0-12; LiPFₓ(R_{F})₆₋ₓ and LiBF_{y}(R_{F})_{4-y} wherein R_{F} represents perfluorinated C₁-C₂₀ alkyl groups or perfluorinated aromatic groups, x=0-5 and y=0-3, LiBF₂[O₂C(CX₂)ₙCO₂], LiPF₂[O₂C(CX₂)ₙCO₂]₂, LiPF₄[O₂C(CX₂)ₙCO₂], wherein X is selected from the group consisting of H, F, Cl, C₁-C₄ alkyl groups and fluorinated alkyl groups, and n=0-4; LiN(SO₂CₘF₂ₘ₊₁)(SO₂CₙF₂ₙ₊₁), and LiC(SO₂CₖF₂ₖ₊₁)(SO₂CₘF₂ₘ₊₁)(SO₂CₙF₂ₙ₊₁), wherein k=1-10, m=1-10, and n=1-10, respectively; LiN(SO₂CₚF₂ₚSO₂), and LiC(SO₂CₚF₂ₚSO₂)(SO₂C_{q}F_{2q+1}) wherein p=1-10 and q=1-10; lithium salts of chelated orthoborates and chelated orthophosphates such as lithium bis(oxalato)borate [LiB(C₂O₄)₂], lithium bis(malonato) borate [LiB(O₂CCH₂CO₂)₂], lithium bis(difluoromalonato) borate [LiB(O₂CCF₂CO₂)₂], lithium (malonato oxalato) borate [LiB(C₂O₄)(O₂CCH₂CO₂)], lithium (difluoromalonato oxalato) borate [LiB(C₂O₄)(O₂CCF₂CO₂)], lithium tris(oxalato) phosphate [LiP(C₂O₄)₃], and lithium tris(difluoromalonato) phosphate [LiP(O₂CCF₂CO₂)₃]; and any combination of two or more of the aforementioned salts. Most preferably the electrolytic solution comprises LiPF₆.

The concentration of the solute in the electrolytic solution may be any concentration, but normally from 0.1 to 3.0 M (mol/liter), preferably 0.2 to 2.8 M, more preferably 0.3 to 2.5M, more preferably 0.4 to 2 M and more preferably 0.5 to 1.5M.

Cathode. The cathode comprises at least one lithium mixed metal oxide (Li-MMO). Lithium mixed metal oxides contain at least one other metal selected from the group consisting of Mn, Co, Cr, Fe, Ni, V, and combinations thereof. For example the following Li-MMOs may be used in the cathode: LiCoO₂, LiMnO₂, LiMn₂O₄, Li₂Cr₂O₇, Li₂CrO₄, LiNiO₂, LiFeO₂, LiNiₓCo₁₋ₓO₂ (0<x<1), LiFePO₄, LiVPO₄, (0<z<1) (which includes LiMn_{0.5}Ni_{0.5}O₂), LiMn_{1/3}Co_{1/3}Ni_{1/3}O₂, LiMc_{0.5}Mn_{1.5}O₄, wherein Mc is a divalent metal; and LiNiₓCo_{y}Me_{z}O₂ wherein Me may be one or more of Al, Mg, Ti, B, Ga, or Si and 0<x,y,z<1. Furthermore, transition metal oxides such as MnO₂ and V₂O₅; transition metal sulfides such as FeS₂, MoS₂ and TiS₂; and conducting polymers such as polyaniline and polypyrrole may be present. The preferred positive electrode material is the lithium transition metal oxide, including, especially, LiCoO₂, LiMn₂O₄, LiNi_{0.80}Co_{0.15}Al_{0.05}O₂, LiFePO₄, and LiNi_{1/3}Mn_{1/3}CO_{1/3}O₂. Mixtures of such oxides may also be used.

Anode. The anode material is selected from lithium metal, lithium alloys, carbonaceous materials and lithium metal oxides capable of being intercalated and de-intercalated with lithium ions. Carbonaceous materials useful herein include graphite, amorphous carbon and other carbon materials such as activated carbon, carbon fiber, carbon black, and mesocarbon microbeads. Lithium metal anodes may be used. Lithium MMOs such as LiMnO₂ and Li₄Ti₅O₁₂ are also envisioned. Alloys of lithium with transition or other metals (including metalloids) may be used, including LiAl, LiZn, Li₃Bi, Li₃Cd, Li₃Sb, Li₄Si, Li_{4.4}Pb, Li_{4.4}Sn, LiC₆, Li₃FeN₂, Li_{2.6}Co_{0.4}N, Li_{2.6}Cu_{0.4}N, and combinations thereof. The anode may further comprise an additional material such as a metal oxide including SnO, SnO₂, GeO, GeO₂, In₂O, In₂O₃, PbO, PbO₂, Pb₂O₃, Pb₃O₄, Ag₂O, AgO, Ag₂O₃, Sb₂O₃, Sb₂O₄, Sb₂O₅, SiO, ZnO, CoO, NiO, FeO, and combinations thereof.

Either the anode or the cathode, or both, may further comprise a polymeric binder. In a preferred embodiment, the binder may be polyvinylidene fluoride, styrene-butadiene rubber, polyamide or melamine resin, and combinations thereof.

It is envisioned that the salt additives, electrolytic solutions and batteries discussed herein have a wide range of applications, including, at least, calculators, wrist watches, hearing aids, electronics such as computers, cell phones, and games, and transportation applications such as battery powered and/or hybrid vehicles.

The following compositions and batteries represent exemplary embodiments of the invention. They are presented to explain the invention in more detail, and do not limit the invention.

### Examples

(1) Preparation of a Cathode. A positive electrode slurry was prepared by dispersing LiCoO₂ (as positive electrode active material, 90 wt %), poly(vinylidenfluoride) (PVdF, as bonder, 5 wt %), and acetylene black (as electro-conductive agent, 5 wt %) into 1-methyl-2-pyrrolidone (NMP). The slurry was coated on aluminum foil, dried, and compressed to give a positive electrode.

(2) Preparation of an Anode. Artificial graphite (as negative electrode active material, 95 wt %) and PVdF (as binder, 5 wt %) were mixed into NMP to give a negative active material slurry which was coated on copper foil, dried, and pressed to give a negative electrode

(3) Preparation of Electrolytic Solutions. The Baseline Electrolyte is formed by blending 61.0 g LiPF₆ into 161.1 g EC and 277.9 g EMC to give 500 g baseline electrolyte. To the baseline electrolyte, 0 to 2 wt % of different additive combination were added to create the electrolyte samples 1 to 6 as well as comparative electrolyte samples 1-4, according to table 2.

TABLE 2
Electrolyte Samples from Electrolyte Solution A

| Example | Additive Name | Additive Amount |
|---|---|---|
| Example 1 | VC, PS, Phosphazene E | 1%, 1%, 1% |
| Example 2 | VC, PS, Phosphazene E | 1%, 1%, 7% |
| Example 3 | VC, PS, Phosphazene E | 1%, 2%, 0.5% |
| Example 4 | VC, PS, Phosphazene E | 1%, 0.5%, 2% |
| Example 5 | PS, Phosphazene E | 2%, 1% |
| Example 6 | VC, PS, Phosphazene O | 1%, 1%, 7% |
| Comparative | VC | 1% |
| Example 1 | | |
| Comparative | VC, PS | 1%, 2% |
| Example 2 | | |
| Comparative | VC, Phosphazene E | 1%, 1% |
| Example 3 | | |
| Comparative | VC, PS | 1%, 1% |
| Example 4 | | |

(4) Assembly of a Lithium Ion Secondary Battery. In a dry box under an inert atmosphere, a lithium ion secondary battery was assembled using a prismatic cell. That is, a microporous polypropylene separator, a cathode, another microporous polypropylene separator and an anode were laid on top of each other and then wrapped tightly together. The assembly was then inserted into a one-end-opened prismatic aluminum can. Current leads were attached to both the cathode and anode with proper insulation against each other and connection to the outside terminals. The open end was then covered leaving just a small hole. Then through the hole the electrolytic solution of the electrolyte samples 1 to 6 and the Comparative electrolyte samples 1 to 4 was added to each of the batteries and allowed to absorb to create battery examples 1 to 6 and comparative battery example 1 to 4. Finally, a small steel ball was used to seal the orifice and thus the cell, completing the assembly of the prismatic type lithium ion secondary batteries.

(5) Testing of the Batteries. Evaluation of the aforementioned assembled battery was carried out by initial charging and discharging process (formation and capacity confirmation), followed by life cycle testing and high temperature storage testing.

Initial charging and discharging of the aforementioned assembled battery was performed to form the solid electrolyte interface (SEI) on graphite electrode according to the constant current/voltage charging and the constant current discharging method in a room temperature atmosphere. That is, the battery was first charged up to 3.4 V at a constant current rate of 15 mA, followed by charging at a constant current rate of 110 mA up to 3.95V. The battery was then discharged and charged with normal constant-current constant voltage profile. During charge, after reaching 4.2 V, the battery was continually charged at a constant voltage of 4.2 V until the charging current was less than or equal to 25 mA. Then the battery was discharged at a constant current rate of 275 mA/cm² until the cut-off voltage 3.0 V reached. Standard capacity of a non-aqueous electrolyte secondary battery was 550 mAh.

High temperature storage test was conducted by first charging the aforementioned initially charged/discharged battery under room temperature at a constant current rate of C (550 mA) to 4.2 V and then charged at a constant voltage of 4.2 V until the current was less than or equal to 25 mA. The battery was then discharged at a constant current rate of C (550 mA) until the cut-off voltage 3.0 V was reached. This discharge capacity was noted as the starting discharge capacity. The battery was then charged again under room temperature at a constant current rate of C (550 mA) to 4.2 V and then charged at a constant voltage of 4.2 V until the current was less than or equal to 25 mA. The fully charged battery was stored at oven set at constant temperature of 60° C. for one week. Thickness of the battery was measured before and after the storage when the battery was at both the storage temperature and room temperature. The retained discharge capacity was obtained by constant current discharge at C rate (550 mA) under room temperature after the storage. The recoverable discharge capacity was obtained by continuing cycling the battery the same way as before the storage test.

The thickness increase rate was calculated as

(Thickness before the storage−thickness after the storage)÷thickness after the storage×100%.

The capacity retention ratio was calculated as

retained capacity after the storage÷starting capacity×100%.

The recoverable capacity ratio was calculated as

Recoverable capacity after the storage÷starting discharge capacity×100%

TABLE 3
Thickness increase of prismatic batteries containing different
electrolytes under high temperature storage.

| | Beginning | Thickness | Thickness |
|---|---|---|---|
| | cell | increase rate | increase rate |
| | thickness | measured | measured |
| Example | (mm) | at 60° C. | at RT |
| Example 1 | 4.607 | 6.4% | 2.9% |
| Example 2 | 4.488 | 3.7% | 2.7% |
| Example 3 | 4.432 | 9.6% | 4.9% |
| Example 4 | 4.457 | 16.0% | 8.0% |
| Example 5 | 4.497 | 4.3% | 1.8% |
| Example 6 | 4.512 | 3.7% | 2.8% |
| Comparative | 4.653 | 42.8% | 33.1% |
| Example 1 | | | |
| Comparative | 4.490 | 49.3% | 40.9% |
| Example 2 | | | |
| Comparative | 4.570 | 36.4% | 30.2% |
| Example 3 | | | |
| Comparative | 4.695 | 16.9% | 8.4% |
| Example 4 | | | |

As shown in Table 3, the thickness increase rate of Examples 1-6 according to the present invention were much smaller than those of the comparative examples 1-4, indicating an improvement (reduction) in swelling after storage at high temperature storage.

At the same time, the capacity retention ratios of Examples 1-6 according to the present invention under high temperature storage was also improved (or remained substantially the same as the Comparative Examples), as shown in Table 4.

TABLE 4
High temperature storage capacity retention of prismatic
batteries containing different electrolytes.

| | Beginning | Capacity | Recoverable |
|---|---|---|---|
| | discharge | retention | capacity |
| Example | capacity (mAh) | ratio | ratio |
| Example 1 | 571.4 | 86.2% | 87.4% |
| Example 2 | 550.3 | 92.4% | 96.0% |
| Example 3 | 591.0 | 93.0% | 94.7% |
| Example 4 | 573.5 | 91.6% | 94.3% |
| Example 5 | 569.2 | 93.5% | 94.8% |
| Example 6 | 541.7 | 90.6% | 93.8% |
| Comparative | 565.3 | 64.2% | 63.4% |
| Example 1 | | | |
| Comparative | 557.8 | 77.5% | 77.3% |
| Example 2 | | | |
| Comparative | 576.9 | 86.5% | 88.3% |
| Example 3 | | | |
| Comparative | 515.15 | 81.9% | 85.5% |
| Example 4 | | | |

Cycle life test was conducted at room temperature by charging the aforementioned initially charged/discharged battery at a constant current rate of C (550 mA) to 4.2 V and then charged at a constant voltage of 4.2 V until the current was less than or equal to 25 mA. The battery was then discharged at a constant current rate of C (550 mA) until the cut-off voltage 3.0 V was reached.

The 1^{st} C-rate cycle efficiency and discharge capacity retention of each example cell are shown in Table 4. Discharge capacity retention rate of cycle life (%)=(n^{th} cycle discharge capacity/1^{st} cycle discharge capacity)×100%. NM means not measured.

As shown in table 5, 1^{st} C-rate cycle discharge capacity and capacity retention of Examples 1-6 were improved over Comparative Examples. Overall, only Examples 1-6 according to current invention show the simultaneous improvement both on the thickness aspect and capacity retention aspects.

TABLE 5
Cell performance of prismatic batteries
containing different electrolytes.

| | 1^{st} C-rate | | Discharge capacity | |
|---|---|---|---|---|
| | cycle discharge | 1^{st} cycle | retention | |
| Example | capacity (mAh) | efficiency | 100^{th} cycle | 300^{th} cycle |
| Example 1 | 594.65 | 94.4% | 89.8% | 76.8% |
| Example 2 | 596.32 | 94.7% | 88.0% | 76.1% |
| Example 3 | 603.7 | 95.6% | 90.4% | 81.6% |
| Example 4 | 596.4 | 96.0% | 89.0% | 72.0% |
| Example 5 | 595.6 | 94.0% | n/m | n/m |
| Example 6 | 587.3 | 94.7% | n/m | n/m |
| Comparative | 591.4 | 94.9% | n/m | n/m |
| Example 1 | | | | |
| Comparative | 561.6 | 94.0% | n/m | n/m |
| Example 2 | | | | |
| Comparative | 610.9 | 95.8% | 92.9% | 75.8% |
| Example 3 | | | | |
| Comparative | 561.1 | 93.1% | 85.6% | 55.3% |
| Example 4 | | | | |

Certain embodiments of the invention are envisioned where at least some percentages, temperatures, times, and ranges of other values are preceded by the modifier “about.” “Comprising” is intended to provide support for “consisting of” and “consisting essentially of.” Where ranges in the claims of this provisional application do not find explicit support in the specification, it is intended that such claims provide their own disclosure as support for claims or teachings in a later filed non-provisional application. Numerical ranges of ingredients that are bounded by zero on the lower end (for example, 0-10 wt % VC) are intended to provide support for the concept “up to [the upper limit],” for example “up to 10 wt % VC,” vice versa, as well as a positive recitation that the ingredient in question is present in an amount that does not exceed the upper limit. An example of the latter is “comprises VC, provided the amount does not exceed 10 wt %.” A recitation such as “8-25 wt % (EC+MEC+VC)” means that any or all of EC, MEC and/or VC may be present in an amount of 8-25 wt % of the composition.

While the invention herein disclosed has been described by means of specific embodiments and applications thereof, numerous modifications and variations could be made thereto by those skilled in the art without departing from the scope of the invention set forth in the claims. Furthermore, various aspects of the invention may be used in other applications than those for which they were specifically described herein.

1. A secondary battery comprising:
a. an anode,
b. a cathode, and,
c. an electrolytic solution, comprising
i. a lithium salt
ii. ethylene carbonate,
iii. ethyl methyl carbonate,
iv. a third carbonate,
v. propane sultone, and
vi. a phosphazene compound.

2. The secondary battery of claim 1, wherein the phosphazene compound is selected from the group consisting of ethoxy-pentafluorocyclotriphosphazene, phenoxy-pentafluorocyclotriphosphazene, diethyl-tetrafluorocyclotriphosphazene, N-methyl-trifluorophophazene, N-ethyl-trifluorophophazene, and combinations thereof.

3. The secondary battery of claim 2, wherein the phosphazene compound is present in an amount of 0.01-10% of the electrolytic solution.

4. The secondary battery of claim 1 wherein the third carbonate is selected from the group consisting of vinylene carbonate, methyl ethyl carbonate, propylene carbonate, butylene carbonate, dimethyl carbonate, diethyl carbonate, di(2,2,2-trifluoroethyl)carbonate, dipropyl carbonate, dibutyl carbonate, carbonate, 2,2,2-trifluoroethyl methyl carbonate, methyl propyl carbonate, ethyl propyl carbonate, fluoro ethylene carbonate, 2,2,2-trifluoroethyl propyl carbonate, and combinations thereof.

5. The secondary battery of claim 1, wherein the lithium salt is LiPF₆.

6. The secondary battery of claim 1 wherein the electrolytic solution comprises in wt %:
a. 5-25% LiPF₆
b. 15-50% ethylene carbonate,
c. 35-70% ethyl methyl carbonate,
d. 0-5% vinylene carbonate,
e. 0.01-5% propane sultone, and
f. 0.01-10 wt % of the phosphazene compound.

7. The secondary battery of claim 6, wherein the phosphazene compound comprises ethoxy-pentafluorocyclotriphosphazene.

8. The secondary battery of claim 1, wherein the electrolytic solution further comprises a salt selected from the group consisting of LiBF₄, LiSbF₆, LiAsF₆, LiTaF₆, LiAlCl₄, Li₂B₁₀Cl₁₀, Li₂B₁₂FₓH₍₁₂₋ₓ₎ wherein x=0-12, LiB(C₂O₄)₂, LiB(O₂CCH₂CO₂)₂, LiB(O₂CCF₂CO₂)₂, LiB(C₂O₄)(O₂CCH₂CO₂), LiB(C₂O₄)(O₂CCF₂CO₂), LiP(C₂O₄)₃, LiP(O₂CCF₂CO₂)₃, LiClO₄, LiCF₃SO₃; LiN(SO₂CₘF₂ₘ₊₁)(SO₂CₙF₂ₙ₊₁), LiC(SO₂CₖF₂ₖ₊₁)(SO₂CₘF₂ₘ₊₁)(SO₂CₙF₂ₙ₊₁), wherein k=1-10, m=1-10, and n=1-10, respectively; LiN(SO₂CₚF₂ₚSO₂), and LiC(SO₂CₚF₂ₚSO₂)(SO₂C_{q}F_{2q+1}) wherein p=1-10 and q=1-10; LiPFₓ(R_{F})₆₋ₓ and LiBF_{y}(R_{F})_{4-y}, wherein R_{F} represents perfluorinated C₁-C₂₀ alkyl groups or perfluorinated aromatic groups, x=0-5, and y=0-3; LiBF₂[O₂C(CX₂)ₙCO₂], LiPF₂[O₂C(CX₂)ₙCO₂]₂, LiPF₄[O₂C(CX₂)ₙCO₂], wherein X is selected from the group consisting of H, F, Cl, C₁-C₄ alkyl groups and fluorinated alkyl groups, and n=0-4; and combinations thereof.

9. The secondary battery of 1, wherein the cathode comprises a lithium mixed metal oxide selected from the group consisting of LiCoO₂, LiMnO₂, LiMn₂O₄, Li₂Cr₂O₇, Li₂CrO₄, LiNiO₂, LiFeO₂, LiNiₓCo₁₋ₓO₂ (0<x<1), LiFePO₄, LiVPO₄, LiMn_{0.5}Ni_{0.5}O₂, LiMn_{1/3}CO_{1/3}Ni_{1/3}O₂, LiNiₓCo_{y}Me_{z}O₂ wherein Me may be one or more of Al, Mg, Ti, B, Ga, or Si and 0<x,y,z<1, and LiMc_{0.5}Mn_{1.5}O₄ wherein Mc is a divalent metal, and mixtures thereof.

10. The secondary battery of 1, wherein the anode comprises a material selected from the group consisting of carbonaceous material, lithium metal, LiMnO₂, LiAl, LiZn, Li₃Bi, Li₃Cd, Li₃Sb, Li₄Si, Li_{4.4}Pb, Li_{4.4}Sn, LiC₆, Li₃FeN₂, Li_{2.6}CO_{0.4}N, Li_{2.6}Cu_{0.4}N, Li₄Ti₅O₁₂, and combinations thereof.

11. A method of making a lithium battery or lithium ion battery comprising:
a. providing an electrolytic solution comprising
i. a non-aqueous electrolytic solution comprising
1. a lithium salt
2. ethylene carbonate,
3. ethyl methyl carbonate,
4. a third carbonate,
5. propane sultone, and
6. a phosphazene compound
b. stacking atop one another
i. a first porous separator,
ii. a cathode,
iii. a second porous separator, and
iv. an anode,
c. wrapping the electrodes and separators of (b) tightly together using adhesive to form an assembly,
d. inserting the assembly into an open-ended prismatic aluminum can,
e. attaching respective current leads to respective anode and cathode,
f. adding the electrolytic solution of (a) to the can, and
g. sealing the can.

12. The method of claim 11, wherein the non-aqueous electrolytic solution comprises:
a. 5-25% LiPF₆
b. 15-50% ethylene carbonate,
c. 35-70% ethyl methyl carbonate,
d. 0.01-5% vinylene carbonate,
e. 0.01-5% ethoxypentafluorocyclotriphosphazene, and
f. 0.01-5% propane sultone.

13. The method of claim 11, wherein the lithium salt is LiPF₆.

14. The method of claim 12, wherein the non-aqueous electrolytic solution further comprises a phosphazene compound in an amount of 0.01-10% of the electrolytic solution.

15. The method of claim 15, wherein the phosphazene compound is selected from the group consisting of ethoxy-pentafluorocyclotriphosphazene, phenoxy-pentafluorocyclotriphosphazene, diethyl-tetrafluorocyclotriphosphazene, N-methyl-trifluorophophazene, N-ethyl-trifluorophophazene, and combinations thereof.

16. A method of reducing swelling in a lithium battery or lithium ion battery (as defined by increase in cell thickness measured after storage at 60° C. for 7 days) comprising: fabricating a lithium secondary battery including a non-aqueous electrolytic solution, wherein the non-aqueous electrolytic solution includes
i. LiPF₆
ii. ethylene carbonate,
iii. ethyl methyl carbonate,
iv. vinylene carbonate,
v. propane sultone, and
vi. a phosphazene compound.

17. The method of claim 16, wherein the phosphazene compound is present in an amount of 0.01-10% of the electrolytic solution.

18. The method of claim 16, wherein the phosphazene compound is ethoxy-pentafluorocyclotriphosphazene, phenoxy-pentafluorocyclotriphosphazene, diethyl-tetrafluorocyclotriphosphazene, N-methyl-trifluorophophazene, N-ethyl-trifluorophophazene, and combinations thereof.
